(19) United States
(12) Patent Application Publication
(10) Pub. No.: US 2018/0022594 A1
(43) Pub. Date: Jan. 25, 2018

(54) CONTAINER FOR RECEIVING AND STORING FLUID

(71) Applicant: FIRST ELEMENT PACKAGING INC., Calgary, Alberta (CA)

(72) Inventors: Chris Randall, Calgary (CA); Melanie Kobelka, Okotoks (CA); Chris Hurlburt, Calgary (CA)

(73) Assignee: FIRST ELEMENT PACKAGING INC., Calgary, Alberta (CA)

(21) Appl. No.: 15/523,169

(22) PCT Filed: Oct. 30, 2015
(86) PCT No.: PCT/CA2015/051115

§ 371 Date: Apr. 28, 2017

Related U.S. Application Data
(60) Provisional application No. 62/073,682, filed on Oct. 31, 2014.

(51) Int. Cl. B67D 1/04; B67D 1/00; B65D 21/08; B65D 6/34; B65D 77/06; B65D 8/02

(52) U.S. Cl. CPC B67D 1/0462; B65D 77/06; B65D 11/08; B65D 21/086; B65D 11/22; B67D 1/0004; B67D 1/0082; B67D 2001/0098; B67D 2001/0827

(57) ABSTRACT

A fluid container system comprises a bottle having bellows and being moveable from an extended position to dispense the fluid to a compressed position with a smaller internal volume than when in the extended position. The fluid container may also include a bladder housed within the bottle for storing the fluid; a valve demountably engageable to the bottle and the bladder, and the valve is capable of being closed to prevent the flow of the fluid and gas, or opened to dispense the fluid and gas. The fluid container may also comprise top and bottom endplates that support the bottle.

### TECHNICAL FIELD

The present disclosure relates to an improved fluid container.

### BACKGROUND

Stainless steel beer kegs typically include a single opening on one end and a tube or spear extending from the opening to the other end. A self-closing valve is opened by a coupling fitting which is attached to the opening when the keg is tapped. The coupling fitting has one or two valves which control the flow of beer out of and gas into the keg. The keg must be kept upright, with the opening on top for the beer to be dispensed. Restaurants and bars often use a pressurized gas system to deliver a beverage from the keg to a dispensing tap. Common pressurization gases are food-grade carbon dioxide, nitrogen, or a combination thereof. The gas is delivered into the headspace at the top of the keg above the beverage. This pressure forces the beverage in turn through the spear, the valve, and the delivery line to the dispensing tap.

However, the gas directly contacts the beverage, so the choice of gas is limited to gases which do not alter the quality of the beverage. For example, beverages which are carbonated with carbon dioxide must be delivered using a carbon-dioxide-pressurized tap system which is unsuitable for beers with dissolved nitrogen. Air or other gases can cause oxidation of the beverage which results in undesirable flavor changes.

The above kegs are suitable for delivery and storage of beer up to around six months. After use the keg must be returned to the brewery with costs incurring for the collection, return and cleaning of a steel keg. Breweries typically maintain an inventory of five to eight times as many kegs as are in use, because empty kegs are left at a bar or restaurant until there is sufficient quantity to make collection worthwhile. Maintaining this inventory of excess kegs has cost and storage requirements.

One-way kegs are filled at a brewery, shipped to a bar or restaurant, and discarded after use. Such kegs enable a brewery to distribute over greater distances and areas. Existing standard delivery modes can be used for outbound kegs. Without inbound kegs, the inventory and infrastructure requirements are simplified. One-way kegs typically formed of molded plastic are attractively cost-efficient since fabrication costs are low. Thus, bars and restaurants may seek to recycle them after use. While some jurisdictions may have mandatory recycling rules which apply to bars and restaurants, recycling may be motivated by customer interest in other jurisdictions.

However, some recycling facilities are unable to process pressurized or previously pressurized containers because of the explosion risk and difficulty in confirming whether the container has been fully depressurized. If the container has not been depressurized, then safe depressurization requires specialist tools, equipment or training. In some jurisdictions, pressurized containers are treated as hazardous waste. Recycling facilities may be unable to process containers with mixed materials. Material separation for pressurized containers is difficult.

### SUMMARY

The present disclosure relates to an improved fluid container. It was surprisingly discovered that by using the improved fluid container disclosed herein, one or more of the following benefits may be realized:

(1) The container is extendible and compressible. In the extended position, the container may be filled completely with fluid to its maximum interior volume. The container is able to withstand an internal pressure which is greater than a pressurized tap system or the pressure developed during the transport of carbonated fluid. When the container is empty, for example prior to filling with liquid, or after the liquid has been dispensed and the container has been depressurized, the container is compressible to between about one quarter to about one half of its maximum interior volume to facilitate efficient storage, transportation, or recycling. Components of the container can be easily separated for recycling in different material streams at recycling facilities.

(2) The container may comprise a single valve which enables filling of fluid, pressurizing, fluid delivery, safe manual depressurization after use, and manual removal of the valve assembly.

(3) The container may comprise a flexible, air-impermeable bladder that is demountably engageable with the valve for storing the fluid and preventing contact of the fluid contained therein with pressurized gas propelled into the container during dispensing. Subsequently, the quality and flavor of the fluid are not compromised, and the choice of pressurized gas is not limited solely to the gas used to carbonate the fluid.

(4) The container may comprise one or more rigid endplates which allow the container to be easily and safely carried; prevent damage during handling and transportation; and allow tapping of the container horizontally or vertically. The one or more endplates facilitate the secure stacking of multiple containers for storage or transport.

Thus, one exemplary embodiment broadly relates to a fluid container comprising: an integrally formed body comprising: a closed bottom portion; a top portion that defines an orifice therethrough, said orifice demountably engageable with a valve component; and an intermediate portion that extends between the closed bottom portion and the top portion, the intermediate portion defining a bellows that is moveable between an extended position and a compressed position while maintaining structural integrity of the integrally formed body.

Another exemplary embodiment broadly relates to a system for receiving a fluid. The system comprises an integrally formed body that comprises: a closed bottom portion; a top portion that defines an orifice therethrough; and an intermediate portion that extends between the closed bottom portion and the top portion, the intermediate portion defining a bellows that is moveable between an extended position and a compressed position while maintaining structural integrity of the integrally formed body. The system also comprises an endplate that is demountably engageable with the closed bottom portion, the top portion or both and a valve that is sealingly demountably engageable with the orifice.

### DESCRIPTION OF THE DRAWINGS

The present disclosure provides a description of exemplary embodiments with reference to the accompanying simplified, diagrammatic, not-to-scale drawings:

FIG. 1 is a perspective front view of one exemplary embodiment of the present liquid container, wherein the container is shown in an extended position;

FIG. 2 is a perspective front view of the liquid container shown in FIG. 1 in a compressed position;

FIG. 3 is a perspective view of an exemplary embodiment of a bottle component for the liquid container shown in FIG. 1;

FIG. 4 is a perspective view of the bottle component shown in FIG. 3 with one exemplary embodiment of a valve component;

FIG. 5 is a perspective view of an exemplary embodiment of a top endplate for the liquid container shown in FIG. 1;

FIG. 6 is a perspective view of an exemplary embodiment of a bottom endplate for the liquid container shown in FIG. 1;

FIG. 7 is a perspective view of an exemplary embodiment of an outer valve section for the liquid container shown in FIG. 1;

FIG. 8 is a perspective view of exemplary embodiment of an inner valve section for the liquid container shown in FIG. 1;

FIG. 9(A) is a side elevation view of an exemplary embodiment of a valve; FIG. 9(B) is a cross-section view taken through line B-B in FIG. 9(A).

FIG. 10 is a sectional view of the liquid container shown in FIG. 1, showing a bladder component disposed within the bottle component of the liquid container;

FIG. 11 is a mid-line sectional view of the bladder component shown in FIG. 10;

FIG. 12 is a perspective view of another exemplary embodiment of a bladder component for use with the liquid container shown in FIG. 1; and

FIG. 13 is a sectional view of another exemplary embodiment of the present liquid container shown in the compressed position.

### DETAILED DESCRIPTION

All terms not defined herein have their common art-recognized meanings. To the extent that the following description is of a specific embodiment or a particular use, it is intended to be illustrative only, and not limiting. The scope of the claims should not be limited by the preferred embodiments set forth in the examples, but should be given the broadest interpretation consistent with the description as a whole.

Where a range of values is provided, it is understood that each intervening value, to the tenth of the unit of the lower limit unless the context clearly dictates otherwise, between the upper and lower limit of that range and any other stated or intervening value in that stated range is encompassed within the present disclosure. The upper and lower limits of these smaller ranges may independently be included in the smaller ranges, subject to any specifically excluded limit in the stated range. Where the stated range includes one or both of the limits, ranges excluding either or both of those included limits are also included.

Unless defined otherwise, all technical and scientific terms used herein have the same meaning as commonly understood by one of ordinary skill in the art to which the present disclosure belongs. Although any methods and materials similar or equivalent to those described herein can also be used in the practice or testing of the present disclosure, a limited number of the exemplary methods and materials are described herein.

Any reference herein to inch or inches as a unit of measure can be converted to centimeter (cm) by multiplying the number of inches by about 2.54. For example, one inch is about 2.54 cm.

Any reference to “psig” or “pound-force per square inch” as a unit of pressure can be converted to kilopascals (kpa) by multiplying the number psig by about 6.89476. For example, one psig is about 6.8947 kpa.

As used herein, the term “compatible” and “compatible materials” means that the materials of which the container is made of will not react chemically, physically or otherwise, with the fluid contents of the container to avoid any part of the container from degrading, weakening or corroding. Compatible materials may also be used to line or coat or more surfaces of the container. Compatible materials may be selected to preserve the containment properties of the container for reducing or avoiding any loss of the fluid contents. Compatible materials may also be non-toxic, bioinert, recyclable, air-impermeable, and light or UV-light impermeable. Optionally, any surface of the container that may come into contact with the fluid contents will comprise compatible materials. Compatible materials may include but are not limited to plastic materials such as: polyethylene terephthalate, polyethylene, low density polyethylene, high density polyethylene, polyvinyl chloride, polypropylene, polystyrene, polyamides, acrylonitrile butadiene styrene, polycarbonate, polycarbonate acrylonitrile blends, polyurethanes, plastarch, phenolics polyepoxide, polyetheretherketone, polytetrafluoroethylene, polymethyl methacrylate, silicone, polysulfone and combinations thereof.

It must be noted that as used herein and in the appended claims, the singular forms “a”, “an”, and “the” include plural referents unless the context clearly dictates otherwise.

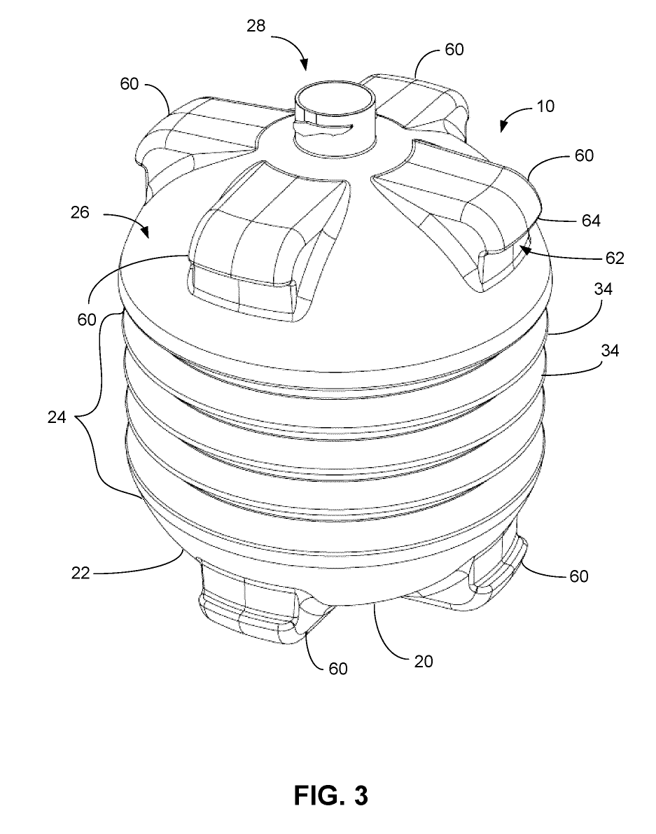

The present disclosure relates to a fluid container (1) (FIGS. 3, 4, 12). The container (1) is configured to store and dispense a variety of fluids. As used herein, the term “fluid” broadly refers to any kind of flowable material including liquids, gases, solids and combinations thereof. Such fluids may include but is not limited to chemicals for industrial processes and chemicals for commercial or residential uses. The fluids may also include food-related fluids. For example, the fluids may be beverages such as alcoholic, non-alcoholic drinks, carbonated or non-carbonated beverages. The container (1) may be used to store and dispense dangerous fluids, such as fluids that comprise hazardous fluids, flammable fluids, explosive fluids, oxidizing fluids, asphyxiating fluids, biohazardous fluids, toxic fluids, pathogenic fluids, allergic-reaction inducing fluids, corrosive fluids, caustic fluids or combinations thereof. The container (1) may also be used to store and dispense liquor, liqueurs, beer, water, soft drinks, mineral water, sports drink, or the like. As discussed further below, the term “fluid” refers to the contents of the container (1) but it does not include any gas that is propelled into the container (1) while the fluid is dispensed from the container (1).

The fluid container (1) generally comprises a bottle (10) that is demountably engageable with a valve (12), a bladder (14), a top endplate (16), and a bottom endplate (18).

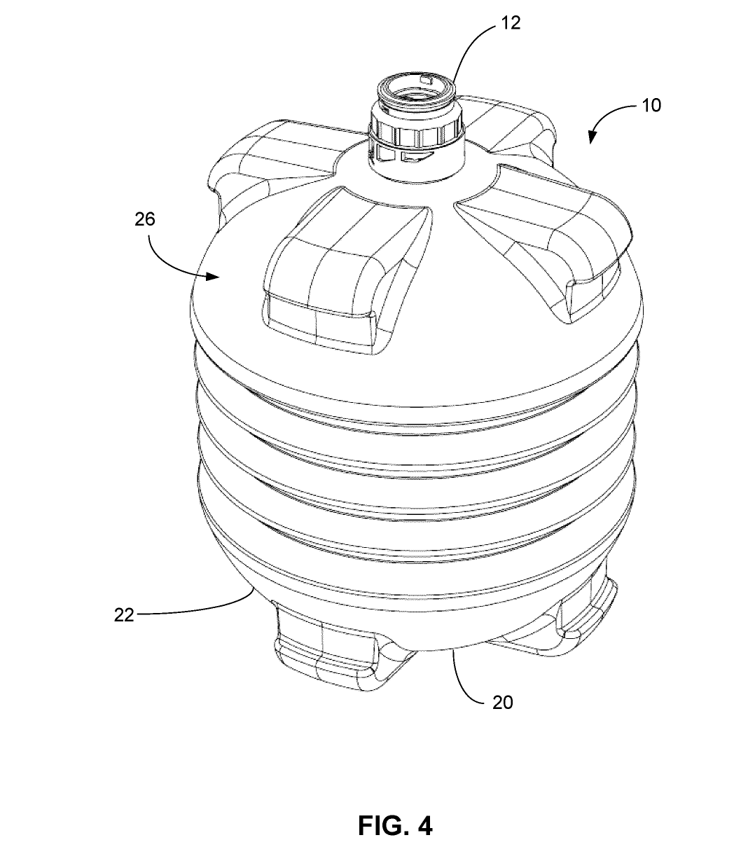

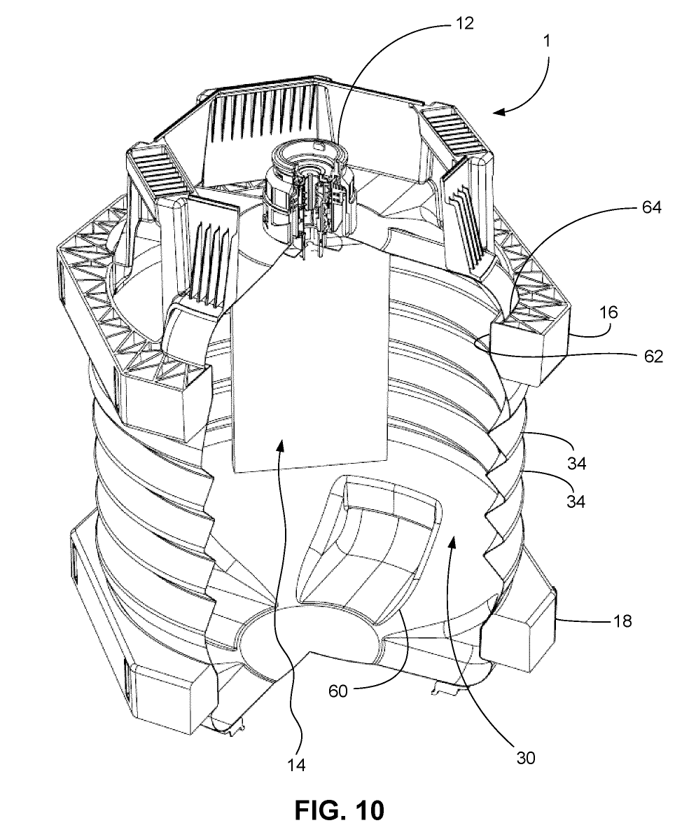

An exemplary embodiment of the present bottle is shown in FIGS. 3 and 4, wherein the bottle (10) comprises a base (20), a heel (22), a body (24), a shoulder (26), and an opening (28) which are formed integrally as one piece to define a unitary hollow plenum or reservoir (30) for housing a bladder (14) (FIG. 10). The valve (12) is sealingly demountably engageable to the opening (28) to seal the bottle (10).

In one exemplary embodiment, the base (20) is substantially horizontal. As used herein, the term “horizontal” means a plane that is substantially parallel to the plane of the horizon. The term “vertical” means a plane that is at a right angle to the horizontal plane. A substantially horizontal base (20) provides a relatively flat surface for the bottle (10) to rest on any underlying support surface while being filled with fluid.

A heel (22) curves upward from the base (20) to the body (24). The heel (22) comprises the portion of the bottle (10) where the body (24) begins to curve into the base (20), namely the transition zone between the horizontal plane of the base (20) and the vertical plane of the body (24).

The body (24) of the bottle (10) comprises a substantially round wall (32) which projects upwardly from the base (20) and defines the hollow reservoir (30) for housing the bladder (14). The body (24) is not limited to the shape or configuration illustrated. In one exemplary embodiment, the body (24) is substantially cylindrically-shaped. In one exemplary embodiment, the body (24) has a diameter ranging from about 4 inches (about 10.16 cm) to about 18 inches (about 45.72 cm), preferably about 15 inches (about 38.1 cm). In one exemplary embodiment, the body (24) has a height ranging from about 12 inches (about 30.48 cm) to about 48 inches (about 121.92 cm), preferably about 23 inches (about 58.42 cm).

In one exemplary embodiment, the body (24) comprises a bellows (34) that enables the bottle (10) to move between a compressed position and an extended position. In the compressed position, the volume of the plenum defined by the body bottle (10) is smaller than the plenum volume when the bottle (10) is in the extended position. While in the compressed position, the structural integrity of the bottle (10) is the substantially the same as when the bottle is in the extended position. The bellows (34) may comprise one or more bellows sections, each section having a ridge and a valley. Preferably, the bellows (34) has between 2 and 10 or more bellows sections. More preferably, the bellows (34) has 4 bellows sections. The ridges and valleys of each bellows section extend around the perimeter of the bottle (10). When in the compressed position, the ridges are positioned proximal to each other and when in the extended position, the ridges are positioned apart from each other. In one exemplary embodiment, the bellows (34) are accordion shaped and arranged about the perimeter of the body (24). The bellows (34) function as stiffening means, allowing the bottle (10) to be easily compressed and then fully extended smoothly without any damage to the bottle (10). The bellows (34) allow the total volume of the bottle (10) to decrease while maintaining the structural integrity of the bottle (10). The compressed position allows a greater number of bottles (10) to be shipped per load, which reduces shipping costs. Furthermore, decreasing the volume of the plenum may facilitate removing fluids from the bottle (10).

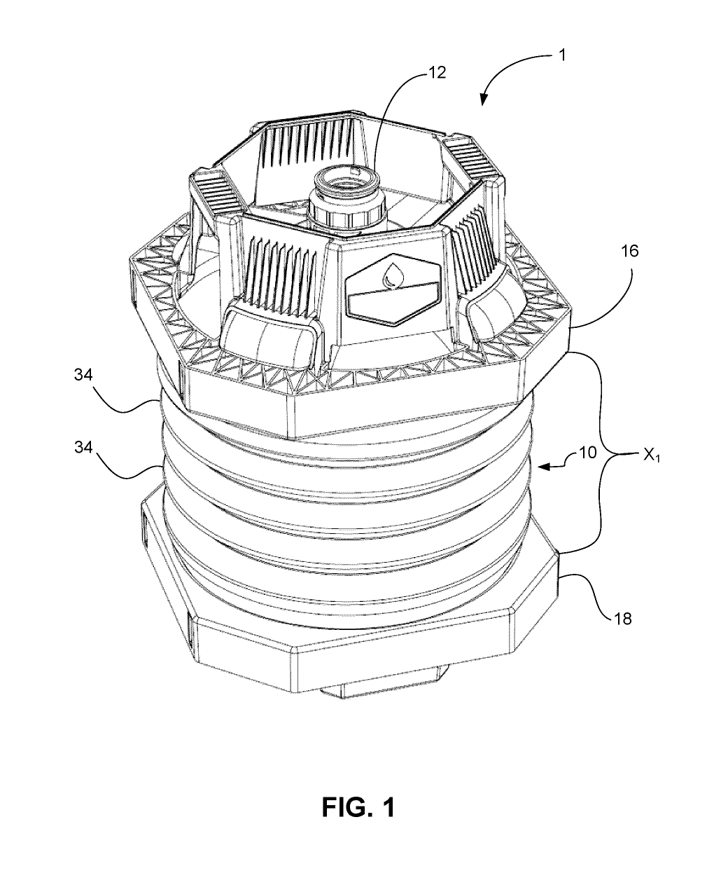

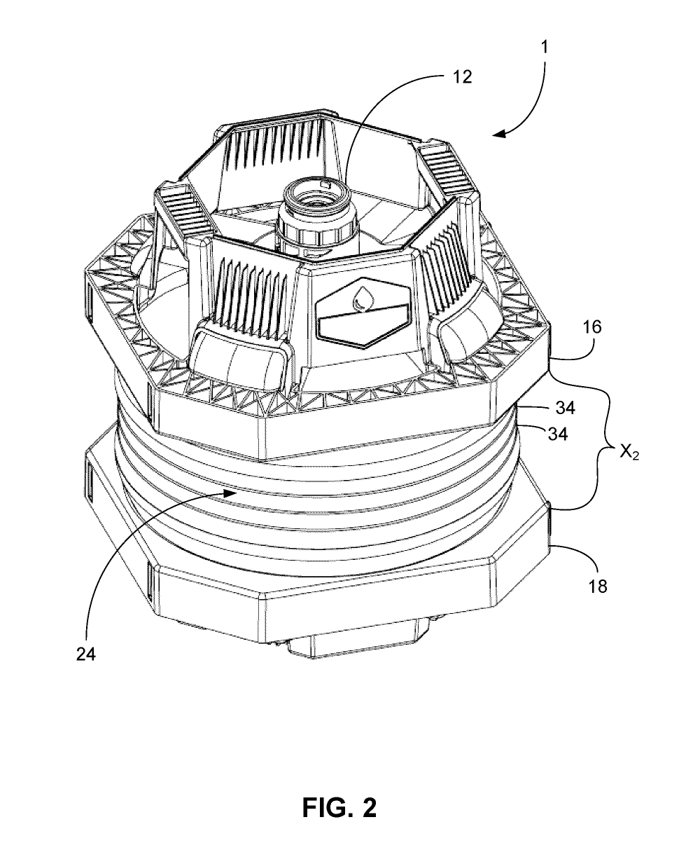

In one exemplary embodiment, the bottle (10) is in the extended position when the hollow reservoir (30) is pressurized. When the bottle (10) is fully extended, the bladder (14) can be empty or partially or fully filled with fluid and the bottle (10) is able to withstand an internal pressure which is greater than a pressurized tap system or the pressure developed during the transport of carbonated fluid. In one exemplary embodiment, the maximum allowable working internal pressure is about 60 psig (about 414 kpa) and the minimum design pressure rating may be about 300 psig (about 2068 kpa) or in a range of about 90 psig (about 620 kpa) to about 150 psig (about 1034 kpa). The bellows (34) of the bottle (10) may be compressed, folded or crushed to facilitate storage, transportation, or recycling. The bottle (10) has a maximum interior volume when filled completely with gas and/or fluid and is compressible to between about one quarter to about one half of the maximal volume. In one embodiment, the maximum interior volume of the bottle (10) may be in a range of about 5 liters to about 60 liters. Preferably, the maximum interior volume of bottle (10) may be between about 40 liters and 60 liters. More preferably, the interior volume of the bottle (10) is about 50 liters. The interior volume of the bottle (10) may be reduced by about half of the maximum interior volume when the bottle (10) is in the compressed position. For example, the distance X1 shown in FIG. 1 represents a portion of the bottle (10) volume when the bellows (34) are in the extended position and the maximum volume of the bottle (10) is available. FIG. 2 shows distance X2 which represents a portion of the bottle's (10) volume when the bellows (34) are in the compressed position. Preferably, X1 is greater than X2.

As shown in FIGS. 3 and 4, the shoulder (26) extends inwardly proximal a point of change in the vertical tangency between the body (24) and the opening (28) (see FIG. 3). In one exemplary embodiment, the heel (22) and the shoulder (26) may each define endplate-engaging elements (60) that extend outwardly from the bottle (10). The endplate-engaging elements (60) are configured to demountably engage the bottle (10) and the endplates (16, 18). In one exemplary embodiment, there may be between 1 and about 10 or more endplate-engaging elements (60) that are defined by both or one of the heel (22) and the shoulder (26). The endplate-engaging elements (60) may be spaced from each other around the perimeter of either or both of the heel (22) and the shoulder (26) to distribute the forces generated at each point where an endplate (16, 18) demountably engages the bottle (10). Distribution of these forces may reduce wear and tear of the bottle (10) and the endplates (16, 18). Preferably, there are four endplate-engaging elements (60) that are substantially evenly spaced around the perimeter of both the heel (22) and the shoulder (26) (see FIG. 3). For example, the four endplate-engaging elements (60) may each be separated from each other about 90 radial degrees when viewed in top plan.

Each endplate engaging member (60) comprises a groove 62 that is defined at least in part by a flange 64. As will be described further below, the groove 62 receives a portion of one of the endplates (16, 18) and the flange 64 engages the endplate (16, 18), either by a friction fit or snap-fit type arrangement.

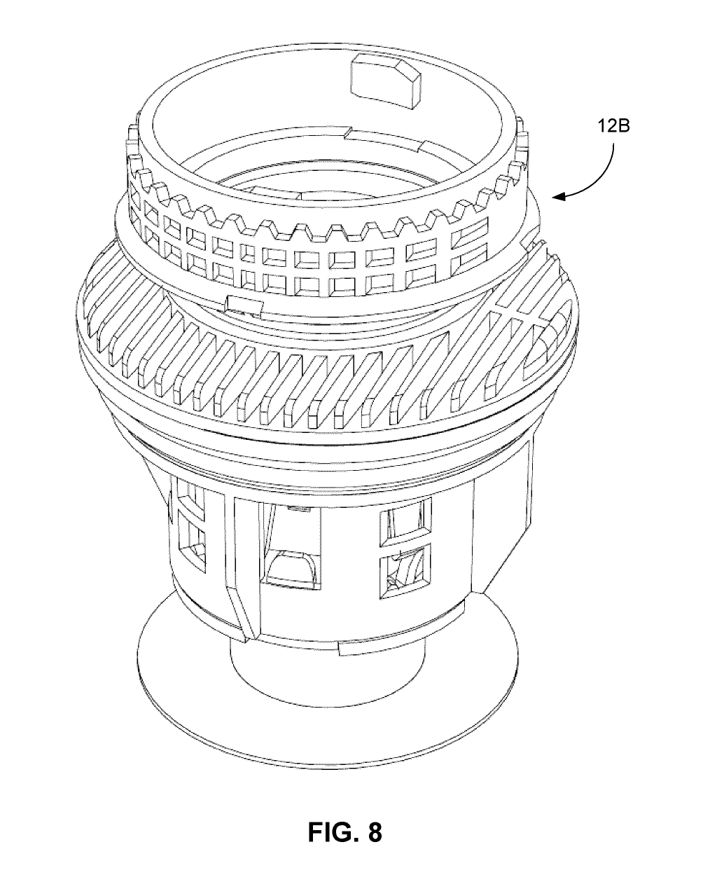

In another embodiment of the bottle (10A), the heel (22) and the shoulder (26) comprises a smooth circumferentially continuous surface which transitions into the base (20) and the opening (28) respectively (see FIG. 8). As used herein, the term “smooth” indicates the absence of any demarcation between portions of the bottle (10). In this embodiment of the bottle (10A), there are no endplate engaging elements (60). The bottle (10A) may connect to the endplates (16, 18) as described further below. The reference number “10” may be used herein to refer to both embodiments of the bottle (10) and bottle (10A).

The bottle (10) may be formed by a blow molding process exemplified by extrusion blow molding, injection blow molding, stretch blow molding, and other processes known in the art which create integrally formed hollow articles. The bottle (10) may be molded as a single, integral unit having the base (20), the heel (22), the body (24), the shoulder (26), and the opening (28). Briefly, the material (for example, plastic) of which the bottle (10) is to be formed is melted and formed into a parison, namely a hollow tube having an opening at one end to allow entry of pressurized gas (for example, air). The parison is loaded onto a stand and encircled by two sides of a bottle-shaped mold. The pressurized gas is blown into the perform to expand and press it against the sides of the mold cavity to form the shape of the bottle (10). The pressure is held until the material cools. Once the material has hardened, the two halves of the mold are separated, and the finished bottle (10) is released. Blow molding is a relatively simple and rapid process for producing the bottle (10).

The bottle (10) may be formed of a material such as plastic, or other suitable material which may be durable, lightweight, relatively inexpensive and compatible with the fluid contents of the container (1). The bottle (10) may be made of lined or coated with compatible materials that will not chemically react with the fluid contents and cause the bottle (10) to degrade, weaken or corrode.

According to one exemplary embodiment, the bottle (10) is formed of polyethylene terephthalate. Polyethylene terephthalate is a clear, transparent plastic which allows the user to observe or inspect the bladder (14) holding the fluid within the bottle (10). Since the bladder (14) is flexible, it will be observed to expand when filled with fluid, and contract when emptied of fluid.

In another exemplary embodiment, the bottle (10) is formed of other materials, such as other types of plastics that are compatible with hazardous fluids, flammable fluids, explosive fluids, oxidizing fluids, asphyxiating fluids, biohazardous fluids, toxic fluids, pathogenic fluids, allergic reaction inducing fluids, corrosive fluids, caustic fluids or combinations thereof. Optionally, one or more surfaces of the bottle (10) may be lined or coated with a material that is compatible with the fluid contents of the container (1).

The opening (28) is configured to sealingly demountably engage the valve (12) in a fluid tight manner. In one exemplary embodiment, the opening (28) has a diameter ranging from about 1 inch (about 2.54 cm) to about 4 inches (about 10.16 cm), preferably about 2.54 inches (about 6.4516 cm). The opening (28) may be positioned substantially at the center of the bottle (10), but any suitable position, including offset from center, is considered within the scope of the present disclosure. In one exemplary embodiment, the opening (28) defines one or more valve engaging elements such as one or more grooves (not shown) that sealingly and demountably engage one or more complementary projections (not shown) of the valve (12) to sealingly and demountably engage the valve (12) to the bottle (10). The one or more grooves of the opening (28) may be oriented vertically, horizontally, or a combination thereof. Alternatively, the one or more valve engaging elements may be projections that sealingly and demountably engage one or more complementary grooves of the valve (12).

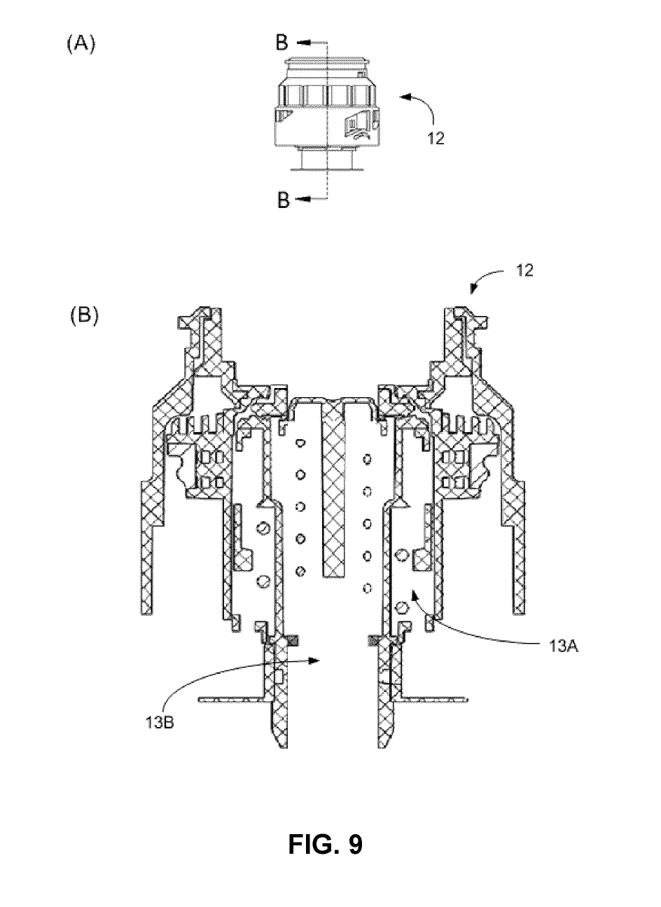

The valve (12) may be two-way in that it enables filling of the bottle (10) with fluid, pressurizing, fluid delivery from the bottle (10), and safe depressurization after use. The valve (12) is configured to be sealingly demountably engaged within the opening (28) of the bottle (10) for sealing the bottle (10), and for cooperation with filling and tapping couplers (not shown) by which pressurized gas is admitted into the bottle (10) and fluid is propelled from the bladder (14). In one exemplary embodiment, the valve (12) comprises an outer channel (13A) which allows pressurized gas to be delivered inside the bottle (10), and an inner channel (13B) which allows the fluid to leave the bladder (14) into delivery lines (see FIG. 9A and FIG. 9B).

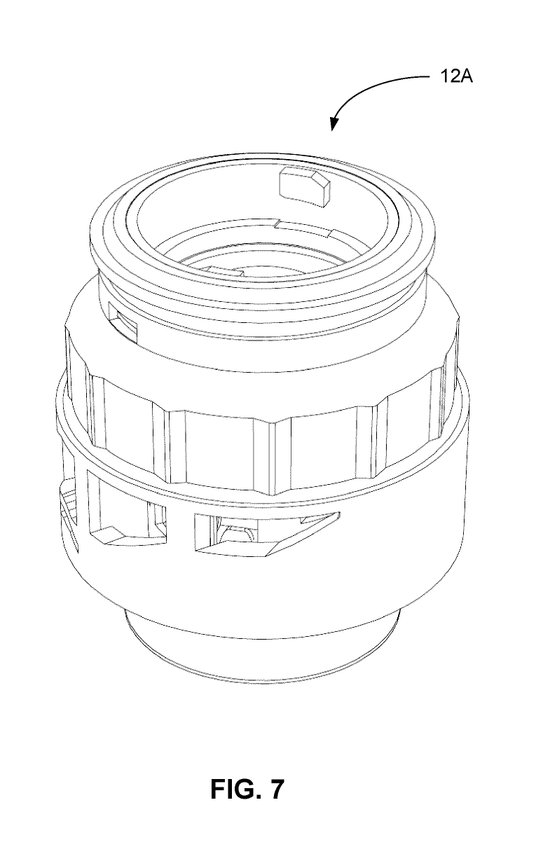

In one exemplary embodiment, the valve (12) is substantially cylindrically-shaped. In one exemplary embodiment, the valve (12) comprises a “D” or American Sankey valve that comprises an outer part 12A and an inner part 12B, as shown in FIGS. 7 and 8. The operation of a standard “D” or American Sankey valve and a D coupler are commonly known to those skilled in the art and will not be discussed in detail. Briefly, the valve (12) comprises a stainless steel rod housing or combination fitting which may be installed into the opening (28) of the bottle (10) and sealed with a spring-loaded check ball. The tapping device or tavern head fits into the lug housing of the valve (12). When the tap is opened, a probe extends and opens the check ball of the combination fitting. Pressurized gas enters the bottle (10) and forces fluid up from the bladder (14) into the delivery line and on to the tap. The combination fitting controls both the fluid flow and gas flow at the valve (12). While the “D” or American Sankey valve is compatible for use with a standard D coupler, it will be recognized by those skilled in the art that other standard couplers may also be accommodated.

In one exemplary embodiment, the valve (12) has a diameter of about 2.5 inches (about 6.35 cm). In one exemplary embodiment, the valve (12) has a height of about 3.5 inches (about 8.89 cm). The valve (12) may be formed of a suitable material including, but not limited to, stainless steel, polyethylene, polypropylene, synthetic rubber and fluoropolymer elastomer, such as VITRON® (VITRON® is a registered trademark of the Chemours Company FC, LLC). The valve (12) may be formed by injection molding or other processes or combinations of processes known in the art.

It will be appreciated by those skilled in the art that any pressurized container is typically equipped with one or more pressure relief assemblies for safety reasons. The valve (12) may include one or more pressure relief assemblies to relieve pressure within the container (1). In one exemplary embodiment, the pressure-relief assembly comprises a burst disk (not shown). Burst discs are commercially available in a variety of sizes, shapes, and with various pressure values. Burst discs are typically pre-weakened by scoring, cutting, or via other standard methods, and rupture when the pressure in the container (1) exceeds the maximum allowable working pressure. In one exemplary embodiment, the pressure-relief assembly comprises manually-operated pressure release means (not shown) to vent any residual pressure when the container (1) is empty. In one exemplary embodiment, the manually-operated pressure release means comprises a vent opening which is sealed by a tear-away covering tab. In one exemplary embodiment, the tear-away tab is a color-coded, pressure-sensitive label which indicates through a color change when the pressure in the container (1) exceeds the maximum allowable working pressure. The tear-away tab can thus be readily removed by manually grasping the tab and tearing or removing the tab to uncover the vent opening, thereby allowing residual pressure to be released at a safe, controlled rate. For safety reasons it may be preferable to require two manual steps to depressurize the container. These can be (i) the tearaway of a tab to uncover the vent, followed by (ii) the depression of a vent opening button. Once removed, the tear-away tab cannot be reattached, thereby preventing the container from being repressurized and reused.

The valve (12) may be demountably engaged with the bottle (10) by any suitable connection means. In one exemplary embodiment, the valve (12) defines one or more projections which engage one or more complementary grooves provided on the opening (28) of the bottle (10) to attach the valve (12) to the bottle (10). In one exemplary embodiment, the opening (28) of the bottle (10) comprises vertical grooves, horizontal grooves or combinations thereof. When the container (1) is pressurized, the valve (12) is forced upwards and the projections are positioned at the top of the vertical grooves. The valve (12) is thereby locked into position and cannot be removed while the bottle (10) is pressurized. In an alternative embodiment, the projections may be defined by bottle (10) at or near the opening (28) for matingly engaging grooves that are defined by the valve (12).

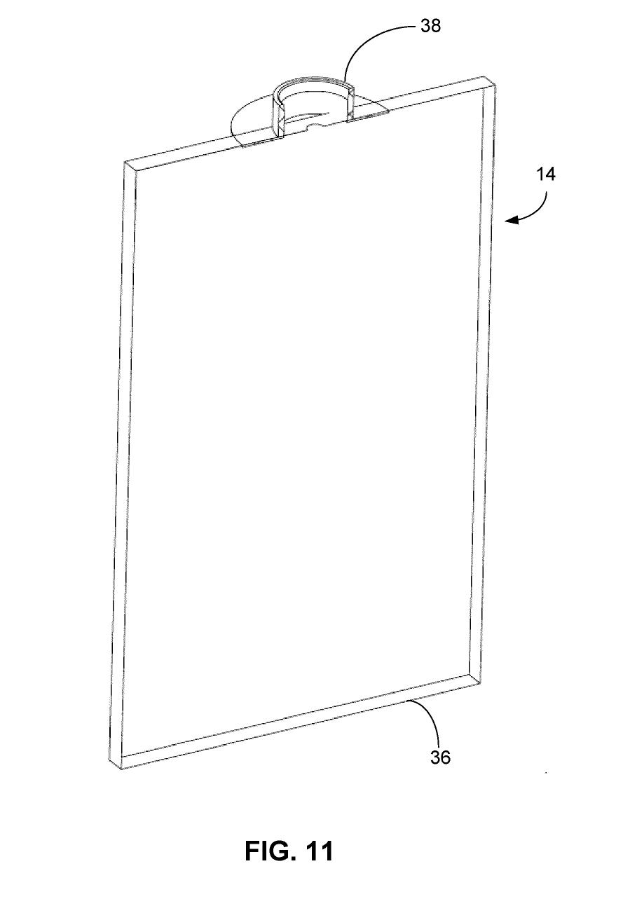

As shown in FIGS. 10 and 11, the bladder (14) is flexible and elastically stretchable to be filled with fluid. The bladder (14) may be formed of various flexible, elastic materials. As used herein, the term “flexible” means capable of stretching without breaking. In one exemplary embodiment, the bladder (14) comprises flexible, elastomeric materials which can widen or contract to accommodate fluid. As used herein, the term “elastomer” means a material which exhibits the property of elasticity, namely the ability to deform when a stress is applied and to recover its original form (i.e., length, volume, shape, etc.) spontaneously when the stress is removed. Elastomers typically have a low Young's modulus (i.e., the ratio of tensile stress to tensile strain, expressed in units of pressure), and a high yield strain (i.e., the stress at which a material begins to deform plastically, expressed in units of pressure). Suitable elastomeric materials include, but are not limited to, polyethylene terephthalate, nylon, or other material. Preferably, the suitable elastomeric materials are compatible with the fluid contents of the bladder (14) in that the compatible materials are also non-toxic, bioinert, recyclable, air-impermeable, and light or UV-light impermeable.

The bladder (14) may be formed of one or more layers of material. In one exemplary embodiment, the bladder (14) may be formed by superimposing one sheet of the material which is cut into the pattern shown in FIG. 11 over a second sheet of material which is cut into a substantially identical pattern. The two sheets of material are then joined together near the periphery of the overlapping sheets to form an air-impermeable seam. The bladder (14) is closed at one end (36) and fitted with a receptacle (38) at the opposite end to allow fluid flow through a valve (not shown) into the bladder (14) during filling, and up through the valve (12) to a delivery line when dispensing. Any of various conventional means can be employed for forming the air-impermeable seam. Such techniques include ultrasonic welding and other thermal fusing techniques.

In one exemplary embodiment, the bladder (14) may be lined internally with a metallic film by coating one side of each of the sheets of material before joining the sheets together to form the seam. In one exemplary embodiment, biaxially oriented polyethylene terephthalate may be aluminized by evaporating a thin film of metal onto it. The metallic film thus directly contacts the fluid.

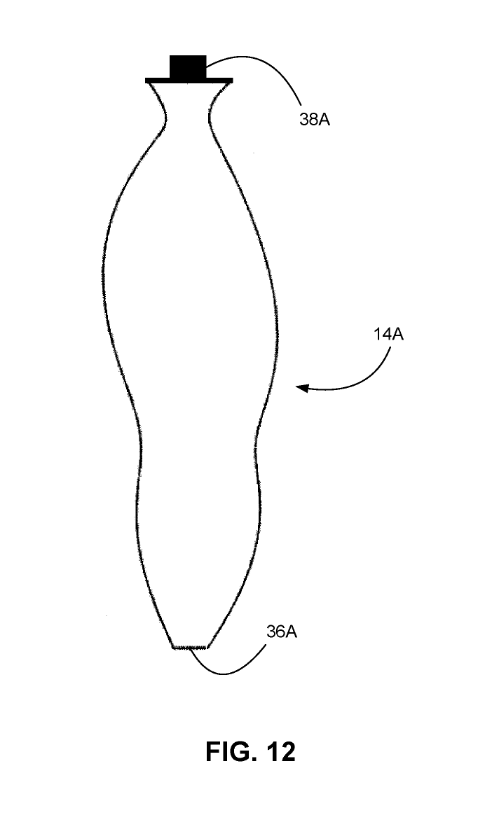

According to another exemplary embodiment shown in FIG. 12, the bladder (14A) may be elongate cylindrically shaped having a closed end (36A) and fitted with a receptacle (38A) at the opposite end to allow fluid flow therethrough a valve (not shown) during filling. The embodiments depicted in FIGS. 11 and 12 can be manufactured by various known techniques that are used to make hollow and flexible articles from the suitable elastomeric materials described above.

As shown in FIG. 10, the bladder (14) may be removably attached to the valve (12) and housed within the hollow reservoir (30) of the bottle (10). The bladder (14) stores the fluid and prevents its contact with pressurized gas propelled into the bottle (10) during dispensing.

The top endplate (16) and bottom endplate (18) are provided to support the bladder (14) and the bottle (10) (FIGS. 1, 2, 5, 6, and 9). Each endplate (16, 18) comprises a front wall (40), a rear wall (42), a first side wall (44), and a second side wall (46). The endplates (16, 18) may define a generally square or rectangular outer shape in top plan view, or the endplates (16, 18) may comprise one or more further walls (43) to define other polygonal shapes, for example octagons. One or more of the front wall (40), rear wall (42), first side wall (44), and second side wall (46) define an aperture (48) for receiving the user's hand therethrough to provide manual support for the container (1).

According to one exemplary embodiment, each endplate (16, 18) defines one or more connection apertures (66) that are configured to demountably engage the endplate-engaging elements (60) of the bottle (10) to releasably connect the bottle (10) to the endplates (16, 18). The flange 64 may engage a surface of the endplate (16, 18) and a portion of an inner surface of each endplate (16, 18) may be received by the groove 62 of each endplate-engaging element (60). Optionally, the connection apertures (66) are defined by one or more of the further walls (42).

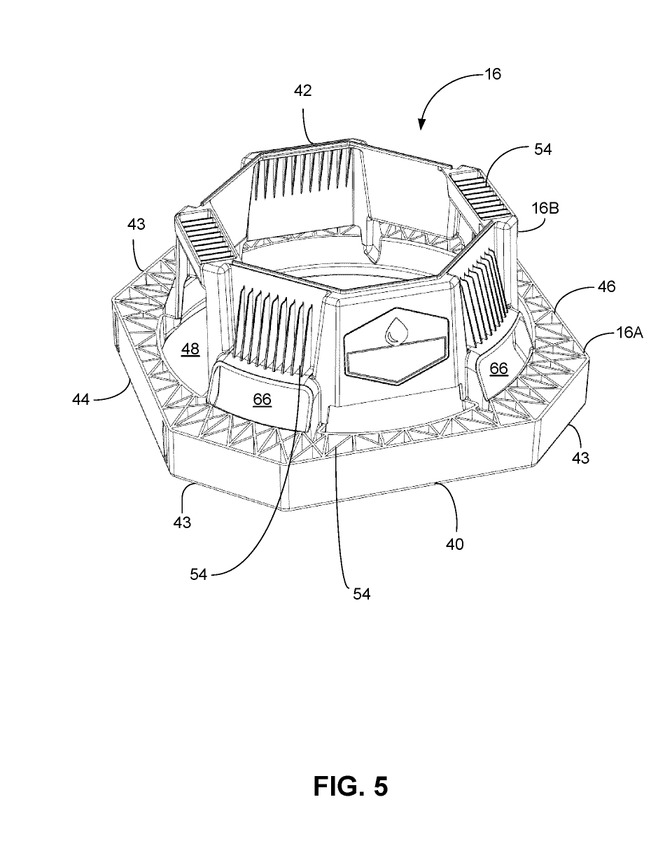

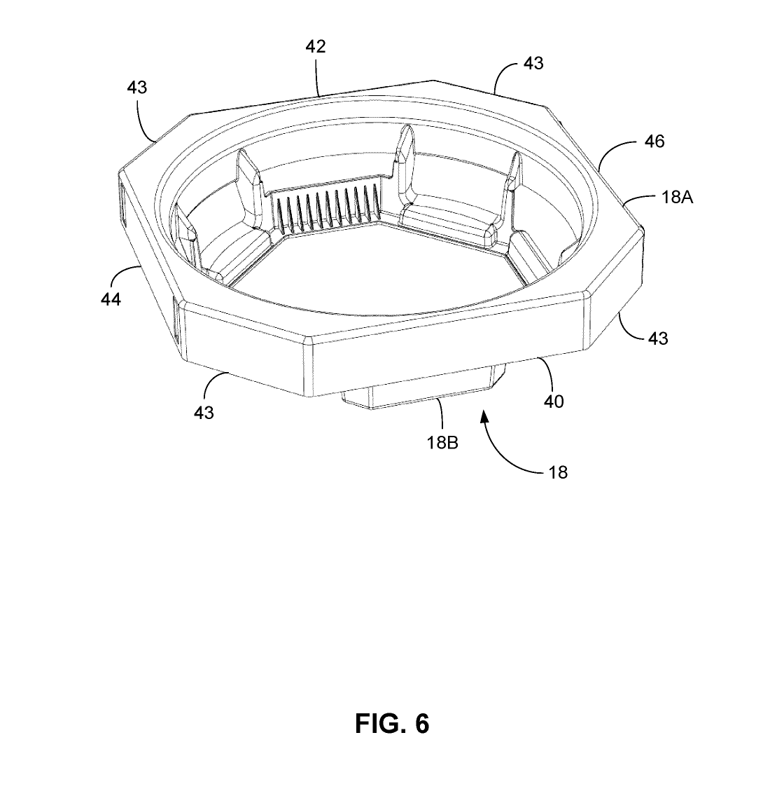

As depicted in FIGS. 5 and 6, the endplates (16, 18) may comprise a first section (16A, 18A) respectively and a second section (16B, 18B) respectively. The first sections (16A, 18A) are configured to encircle each end of the bottle (10) about the bottle's (10) outer diameter. The first sections (16A, 18A) are rigid and may support the bottle (10) when connected to the endplates (16, 18). The second sections (16B, 18B) extend from an inner surface of the first sections (16A, 18A) to define the one or more apertures (48) and the one or more connection apertures (66). In an optional embodiment that reduces the total amount of material required to form the endplates (16, 18), the second sections (16B, 18B) may define a smaller outer diameter than the first sections (16A, 18A). Alternatively, the first sections (16A, 18A) and the second sections (16B, 18B) may define substantially similar outer diameters (see FIG. 8).

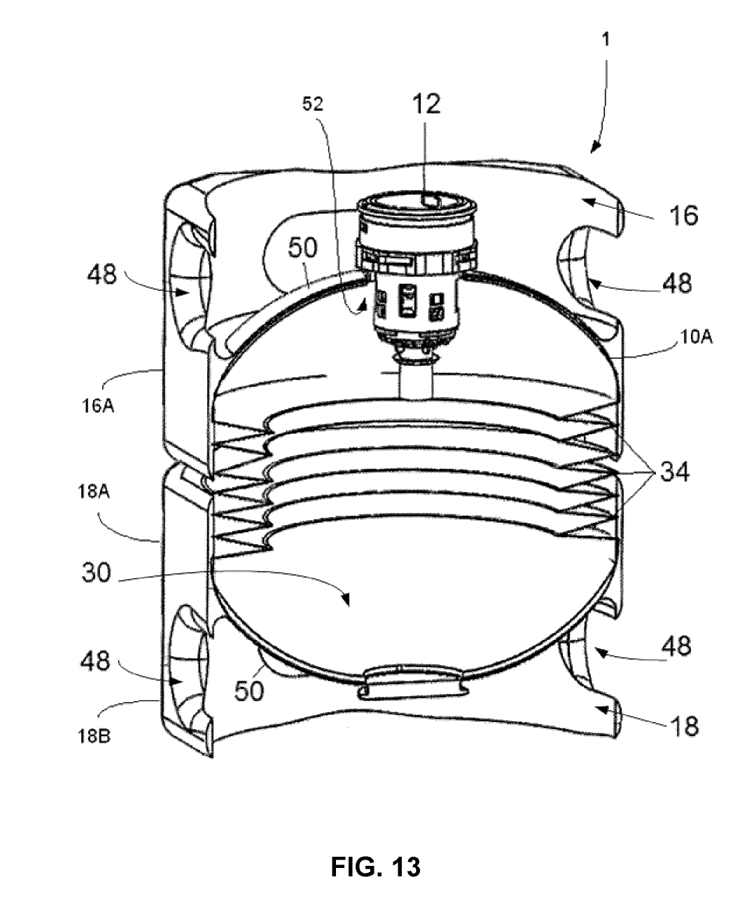

In exemplary embodiments of the bottle (10B) that do not include endplate engaging elements (60), each endplate (16, 18) defines a generally dome-shaped recess (50) disposed within its walls (40, 42, 44, 46) (see FIG. 13). The upwardly extending recess (50) of the top endplate (16) is configured for engagement with the shoulder (26), and defines an aperture (52) for receiving the valve (12) therethrough. The downwardly extending recess (50) of the bottom endplate (18) is configured for engagement with the base (20) and the heel (22) of the bottle (10). Each recess (50) may be press-fit or click-fit to engage the shoulder (26), or base (20) and heel (22) of the bottle (10) respectively, in a secure manner. In one exemplary embodiment, click-fit means (not shown) are defined on the inner surface of the dome-shaped recess (50) and are complementary to a joint (34) positioned at the top or bottom of the body (24) so as to be engaged and secured when the bottle (10) is pressurized.

Optionally, each endplate (16, 18) defines one or more recesses (not shown) and one or more clips (not shown) to receive and secure the delivery and gas lines.

The endplates (16, 18) are preferably constructed from a rigid material exemplified by high density polyethylene, and the like. Since the endplates (16, 18) are rigid, the container (1) may be easily and safely carried, and damage to the container (1) during handling, transportation, or accidental dropping may be prevented. The endplates (16, 18) may be formed by injection molding or other processes known in the art.

Optionally, the endplates (16, 18) may comprise one or more stiffeners (54), such as ribs, honeycomb or web-like structures that provide further stiffening and rigidity to the endplates 16, 18. The stiffeners 54 provide sufficient stiffening and rigidity so that less material may be required to form endplates (16, 18) of the desired rigidity. For example, FIG. 5 shows the use of stiffeners (54) within the first section (16A) and the second section (18A). The stiffeners (54) within the first part (16A) may be oriented to support the top endplate (16) against compressive loads while the stiffeners within the second part (16B) may be oriented to support against the loads that may be exerted on the aperture (48) and the connection apertures (66). A similar arrangement of stiffeners (54) may also be used in the bottom endplate (18).

In one exemplary embodiment, the endplates (16, 18) are substantially identical in dimensions. It is particularly preferred to have the endplates (16, 18) substantially identical since this lends itself to the possibility of making endplates (16, 18) of substantially identical size, shape, and structure, thereby simplifying and reducing manufacturing costs. Two substantially identical endplates (16, 18) may be constructed, with the first endplate (16) being attached to the shoulder (26) of the bottle (10). When reversed, the second endplate (18) is attached to the base (20) and heel (22) of the bottle (10). However, if desired, it is contemplated that the size, shape, and structure of the endplates (16, 18) may vary.

In one exemplary embodiment, the endplates (16, 18) may have a width ranging between about 4 inches (about 10.16 cm) to about 18 inches (about 45.72 cm), preferably about 9.25 inches (about 23.495 cm). In one exemplary embodiment, the endplates (16, 18) have a height ranging between about 3 inches (about 7.62 cm) to about 12 inches (about 30.48 cm), preferably about 6 inches (about 15.24 cm). The shape of the endplates (16, 18) is not limited to that of the present example, but may variously be changed, for example, into a square, rectangle, hexagon, octagon, or the like.

The top endplate (16) overlies the shoulder (26) and protects the valve (12) from being damaged. The base (20) and heel (22) of the bottle (10) are seated and supported within the bottom endplate (18). When the bottle (10) is in the extended position (FIG. 10), the hollow reservoir (30) can be pressurized to stiffen the container. For example pressurization with gas or air to 5 psig (about 34 kpa) or above gives sufficient rigidity to allow stacking of the filled containers. When the bottle (10) is in the extended position, the bladder (14) can be empty or can be filled with fluid, and the endplates (16, 18) support both the bottle (10) and bladder (14). When the bottle (10) is in the compressed position (FIG. 2), the bladder (14, not shown in FIG. 2 for clarity) is empty due to lack of fluid either prior to filling or after dispensing. The top and bottom endplates (16, 18) move closer together as the bottle (10) is compressed. In one exemplary embodiment, the top and bottom endplates (16, 18) are provided with locking means (not shown) to be fastened together, thereby maintaining the container (1) in the compressed position. The locking means can 12 be disconnected to allow the container (1) to be re-extended. In a further embodiment, the compressed configuration is held by applying a vacuum to the container and maintaining negative pressure within the container.

It will be recognized by those skilled in the art that multiple containers (1) may be required for use in various locations such as, for example, a restaurant, lounge, or bar. In one exemplary embodiment, the shapes of the endplates (16, 18) may be varied to allow multiple containers (1) to be stacked vertically or horizontally with one or two endplates (16, 18). In one exemplary embodiment, the container (1) may comprise a spacer (not shown) which enables multiple containers (1) to be stacked and tapped vertically while still allowing access to the valve (12). In one exemplary embodiment, the endplates (16, 18) may include at least one interlocking member (not shown) to allow the containers (1) to be stacked more securely.

The bottle (10) may be molded as a single, integral unit combining the base (20), the heel (22), the body (24), the shoulder (26), and the opening (28). The valve (12) and endplates (16, 18) are manufactured separately as components which are removably attachable to the bottle (10). The bladder (14) is manufactured separately as a component which is removably attachable to the valve (12).

The container (1) may then be assembled with the components attached in sequence; for example, the bladder (14) is attached to the valve (12). The endplates (16, 18) are fitted to the bottle (10). The valve (12) and bladder (14) together are then inserted through the opening (28) into the bottle (10). The valve (12) is connected to the bottle (10) by engaging the valve projections with the complementary grooves of the opening (28). The bottle (10) is then pressurized to test the integrity of the connection between the valve (12) and the bottle (10) and to seat the valve (12) in the vertical grooves of the opening (28). In one exemplary embodiment, a pressure of between about 60 psig (about 414 kpa) and 90 psig (about 620 kpa) is applied for about 30 seconds. The container (1) is then depressurized and vacuum sealed to maintain the container (1) in the compressed position for transportation and storage to a filling facility. Multiple empty containers (1) may be securely stacked together.

In one exemplary embodiment, the dimensions of the compressed container are optimized for efficient storage and transport using standard shipping pallets. For example, the compressed configuration has overall dimensions of 15.5 inches (about 39.37 cm) by 15.5 (about 39.37 cm) inches by 12.5 inches (about 31.75 cm) high (FIG. 2) such that about 27 compressed containers can be stacked on a single standard sized shipping pallets, such as those that are 48 inches by 48 inches (about 121.92 cm by about 121.92 cm).

At the filling facility, the container (1) is briefly filled with partial pressure to expand the bottle (10) and to open the bladder (14). The fluid is forced into the bladder (14). Optionally, a minimal amount of controlled headspace of gas matching the gas desired within the fluid is introduced into the bladder (14). Pressurized gas is introduced into the bottle (10) to establish a standard pressure for storage and transport of the container (1). Multiple containers (1) containing the same or different fluids may be securely stacked for transport to various locations such as, for example, a restaurant, lounge, or bar.

At the location, the container (1) is connected to a pressurized delivery system including a pressurized gas line and a delivery line to deliver the fluid to the taps. The container (1) can be tapped horizontally or vertically. Pressurized gas (for example, carbon dioxide or nitrogen) is delivered through the valve (12) into the bottle (10), particularly into the portion of the hollow reservoir (30) external to the bladder (14). Acting as a propellant for the fluid, the pressurized gas exerts pressure on the bladder (14) and forces the fluid out of the bladder (14) and through the delivery line to the taps. Since the pressurized gas does not contact the fluid, the quality and flavor of the fluid are preserved, and the choice of gas is not limited. The gas does not have to match the gas used to carbonate the fluid. Different gases including, but not limited to, air and non-food grade gas, may be used,

When the bladder (14) is empty, the pressurized gas line and the delivery line are disconnected. The tear-away tab of the valve (12) is removed by manually grasping the tab and tearing or removing the tab to uncover the vent opening, thereby allowing residual pressure to be released at a safe, controlled rate. If a two-step depressurization is required, then the tear-away tab of the valve (12) uncovers a depressurization button which is then depressed to open the vent. After safe depressurization, the valve (12) is manually removed.

The container can be compressed in the manufacturing facility prior to filling without activating the tear-away depressurization mechanism. After the container has been used and is empty, the container can be manually depressurized and compressed using the tear-away depressurization mechanism. This would typically be done in a bar or restaurant.

In one exemplary embodiment, the container (1) is intended for single use and the irreversibly tear-away depressurization mechanism prevents repressurization and reuse. The container (1) may be compressed to reduce its volume during storage or shipping before disposal or recycling. Since the container (1) is no longer pressurized and the valve (12) has been removed, the separate components can be easily recycled in different material streams at recycling facilities.

In another embodiment, fluid may be stored within the bottle (10) rather than inside the bladder (14). This embodiment may further require a spear that extends from the bottom of the valve (12) towards the base (20). Alternatively, this embodiment may deliver fluid from the bottle (10) by gravity rather than a gas-pressure driven system. This embodiment may further require that the inner surface of the bottle is lined or coated with a material that is compatible with the fluid contents of the bottle (10).

What is claimed is:

1. A container for receiving fluids comprising:
a. an integrally formed body comprising:
i. a closed bottom portion;
ii. a top portion that defines an orifice therethrough, said orifice demountably engageable with a valve component; and
iii. an intermediate portion that extends between the closed bottom portion and the top portion, the intermediate portion defining a bellows that is moveable between an extended position and a compressed position while maintaining structural integrity of the integrally formed body.

2. The container of claim 1, wherein the bellows comprises at least two adjacent bellows sections that are each moveable between the extended position and the compressed position.

3. The container of either of claim 1, wherein the closed bottom portion, the top portion or both define at least one endplate-engaging element.

4. The container of claim of 3, wherein the closed bottom portion, the top portion or both define two pairs of endplate-engaging elements.

5. The container of claim 4, wherein the each of the two pairs of endplate-engaging elements comprise individual endplate-engaging elements that are diametrically opposed to each other.

6. The container of claim 5, wherein the two pairs of endplate-engaging elements are substantially evenly and radially spaced from each other.

7. The container of claim 1, further comprising a pressure-relief assembly.

8. The container of claim 7, wherein the pressure-relief assembly comprises a manually operated relief mechanism.

9. The container of claim 8, wherein the manually operated relief mechanism comprises a valve opening that is coverable by a tear-away tab.

10. The container of claim 1, wherein the integrally formed body defines an internal plenum with a volume, wherein when the bellows is in the extended position the volume of the internal plenum is larger than when the bellows is in the compressed position.

11. A system for receiving a fluid comprising:
a. an integrally formed body that comprises:
i. a closed bottom portion;
ii. a top portion that defines an orifice therethrough; and
iii. an intermediate portion that extends between the closed bottom portion and the top portion, the intermediate portion defining a bellows that is moveable between an extended position and a compressed position while maintaining structural integrity of the integrally formed body;
b. an endplate that is demountably engageable with either the closed bottom portion, the top portion or both; and
c. a valve that is sealingly dernountably engageable with the orifice.

12. The system of claim 11, wherein the bellows comprises at least two adjacent bellows sections that are each moveable between the extended position and the compressed position.

13. The system of claim 11, further comprising a second endplate that is demountably engageable with the top portion.

14. The system of claim 13, wherein the endplate, the second endplate or both further comprise at least one interlocking member.

15. The system of claim 11, wherein the closed bottom portion, the top portion or both define at least one endplate-engaging element for demountably engaging the endplate.

16. The system of claim 11, wherein the endplate is demountably engageable with a first endplate-engaging element that is defined by the closed bottom portion and a second endplate is demountably engageable with a second endplate-engaging element that is defined by the top portion.

17. The system of claim 11, wherein the endplate comprises stiffening elements.

18. The system of claim 11, wherein the valve is a two-way valve that permits receiving of fluids within the integrally formed body and dispensing of fluids from the integrally formed body.

19. The system of claim 11, further comprising a bladder that is demountably engageable with one end of the valve within the integrally formed body.

20. The system of claim 11, wherein the integrally formed body further comprises a pressure-relief assembly.

21. The system of claim 20, wherein the pressure-relief assembly comprises a manually operated relief mechanism.

22. The container of claim 21, wherein manually operated relief mechanism comprises a valve opening that is coverable by a tear-away tab.

23. The system of claim 11, further comprising a further integrally formed body with at least one further endplate that is demountably engageable with the further integrally formed body, wherein the integrally formed body and the further integrally formed body are stackable by contacting the at least one endplate and the at least one further endplate.

24. The system of claim 13, wherein the at least one endplate and the second endplate are substantially identical.

25. The system of claim 11, wherein the integrally formed body defines an internal plenum with a volume and when the bellows is in the extended position the volume of the internal plenum is larger than when the bellows is in the compressed position
